(19) United States
(12) Patent Application Publication
(10) Pub. No.: US 2024/0423867 A1
(43) Pub. Date: Dec. 26, 2024

(54) SELF ADJUSTING ROLLER FOR USE WITH EXERCISE EQUIPMENT

(71) Applicant: Bulletproof Fitness Equipment Inc, Acton, CA (US)

(72) Inventors: Lawrence R. Nolan, Santa Clarita, CA (US); Nicole K. Nolan, Santa Clarita, CA (US); Christopher I. Gaddy, Brooklyn, NY (US)

(21) Appl. No.: 18/752,457

(22) Filed: Jun. 24, 2024

Related U.S. Application Data
(60) Provisional application No. 63/509,556, filed on Jun. 22, 2023.

(51) Int. Cl. A61H 15/00

(52) U.S. Cl. CPC A61H 15/00; A61H 2015/0014; A61H 2201/0107; A61H 2201/0119; A61H 2201/0196; A61H 2201/1261

(57) ABSTRACT

A self-adjusting roller for user with an exercise machine includes a plate with apertures extending through the plate; a rotating connection extending from the plate, the rotating connection having a center body with a member extending therefrom and a support extending therefrom, the center body having a center axis around which the center body can rotate; a pin receiver coupled to the center body via the member; and a pin extending into the pin receiver, the pin receiver selectively supporting the pin in a locked configuration and in a free configuration. When in the locked configuration, the pin extends through a selected one of the apertures; and when in the free configuration, the pin is retained out of any of the apertures. A user engageable apparatus is coupled to the support.

### CROSS REFERENCE TO RELATED APPLICATIONS

This application claims the benefit of priority of U.S. Provisional Application No. 63/509,556, filed Jun. 22, 2023, the disclosure of which is herein incorporated by reference in its entirety.

### FIELD OF INVENTION

The disclosure relates generally to exercise equipment. More specifically, the disclosure relates to a self-adjusting roller for attaching to an exercise machine, wherein the roller allows for selectively locking a pad at a desired position or allowing the pad to free-float and self-adjust during use.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

According to an embodiment of the current disclosure, the invention includes a self-adjusting roller for user with an exercise machine. The self-adjusting roller comprises a connection assembly and a user engageable apparatus. The connection assembly includes a plate with a plurality of apertures extending through the plate; a rotating connection extending from the plate, the rotating connection having a center body with a member extending therefrom and a support extending therefrom, and a center axis around which the center body can rotate; a pin receiver coupled to the center body via the member; and a pin extending into the pin receiver, the pin receiver selectively supporting the pin in a locked configuration and in a free configuration. When in the locked configuration, the pin extends through a selected one of the plurality of apertures, and when in the free configuration, the pin is retained out of any of the plurality of apertures. The user engageable apparatus is coupled to the support and is configured to be manipulated by a user during an exercise. The user can select between the locked configuration and the free configuration, wherein the free configuration allows the user engageable apparatus to self-adjust during use.

According to another embodiment of the current disclosure, the invention includes a combination of a self-adjusting roller and a hex port sleeve as part of an exercise machine. The self-adjusting roller has a connection assembly and a user engageable apparatus. The connection assembly includes a plate with a plurality of apertures extending through the plate; a rotating connection extending from the plate, the rotating connection having a center body with a member extending therefrom and a support extending therefrom, the center body further having a center axis around which the center body can rotate; a pin receiver coupled to the center body via the member; a pin extending into the pin receiver, the pin receiver selectively supporting the pin in a locked configuration and in a free configuration; and a connector extending from the plate. When in the locked configuration, the pin extends through a selected one of the plurality of apertures and when in the free configuration, the pin is retained out of any of the plurality of apertures. The user engageable apparatus is coupled to the support and is configured to be manipulated by a user during an exercise. The user can select between the locked configuration and the free configuration, wherein the free configuration allows the user engageable apparatus to self-adjust during use. The hex port sleeve includes a trolley forming a channel to receive a post of the exercise machine; a trolley pin extending into the channel to lock the trolley at a location along the post; a receiver coupled to the trolley, the receiver having a port to receive the connector, thereby coupling the self-adjusting roller to the hex port sleeve; and a locking pin extending into the port to lock the connector therein.

### BRIEF DESCRIPTION OF THE DRAWINGS

Embodiments of the invention are described in detail below with reference to the attached drawings.

FIG. 1 is a front view of a self-adjusting roller in accordance with the present disclosure.

FIG. 2 is a side angled view of the self-adjusting roller of FIG. 1 attached to an exercise machine in accordance with the present disclosure.

FIG. 3 is a side angled view of the self-adjusting roller of FIG. 1 attached to the exercise machine in accordance with the present disclosure.

FIG. 4 is a front view of the self-adjusting roller of FIG. 1 attached to the exercise machine in accordance with the present disclosure.

FIG. 5 is a perspective view of a hex port sleeve for use with the self-adjusting roller of FIG. 1 in accordance with the present invention.

### LIST OF REFERENCES

100—Self Adjusting Roller
102—Connection Assembly
104—Plate
105—Pin Receiver
106—Aperture(s)
107—Rotating Connection
108—Locking Pin
110—Connector
112—Central Axis
114—Hexagonal Section(s)
115—Member
116—Support
118—Pad
200—Exercise Machine
201—Hex Port Sleeve
202—Trolley
204—Post
206—Trolley Pin
208—Aperture(s)
210—User Support System
500—Channel
502—Protective Sleeve
504—Receiver
506—Locking Pin
508—Hexagonal Port
510a-b—Locking Bolts

The drawings do not limit the invention to the specific embodiments disclosed and described herein. The drawings are not necessarily to scale, emphasis instead being placed upon clearly illustrating various principles of the disclosure.

### DETAILED DESCRIPTION

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

Exercise equipment is well known in the art and varies from complex machinery to simple devices, wherein a user may select various equipment based on their needs. Some machines or systems utilize a pad that extends from a machine, such as from a support bar or support post, such that the user can engage with the pad during one or more exercise movements. For example, during an exercise, the user may rest or support their body on a body support system, and utilize a pad to retain their legs/feet for support. It is desirable for these pads to be adjustable to fit users of varying heights.

Accordingly, the present invention provides for a self-adjusting roller that includes a connection assembly that allows for a user to either select a desired (locked) position of an associated pad or select for the pad to be free-floating and therefore self-adjust during use. The second, or self-adjusting/free, configuration allows for the roller to be quickly and effectively utilized by a plurality of users without the need to constantly change a position of the pad. This is achieved via a unique connection assembly described herein.

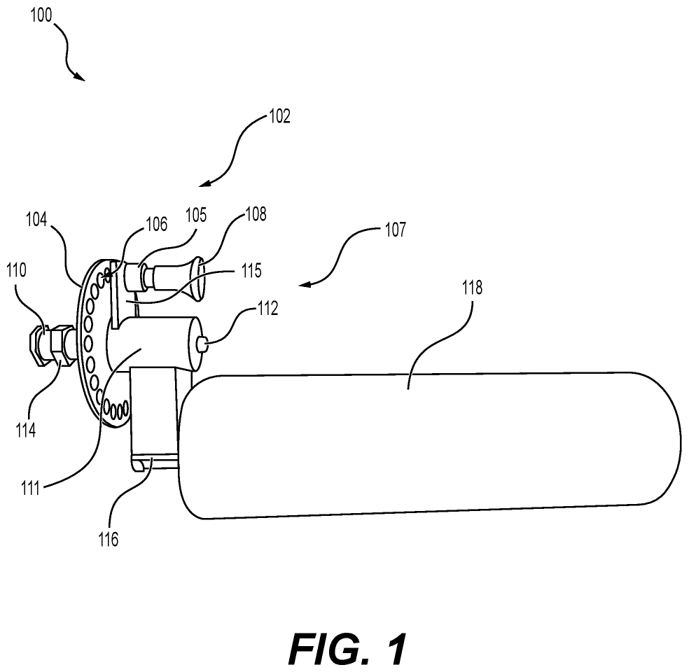

FIG. 1 shows the self-adjusting roller 100 in accordance with the present invention. As shown, the self-adjusting roller 100 includes a connection assembly 102 having a plate 104 with a plurality of apertures 106 extending through the plate 104. The plurality of apertures 106 extend around the plate 104 such that 360 degrees of adjustability is provided for. A rotating connection 107 extends from the plate 104, the rotating connection 107 having a center body 111 with a central axis 112. The center body 111 is configured to rotate around the central axis 112. The center body 111 structurally supports a member 115 extending therefrom in a first direction and a support 116 extending therefrom in a second direction. Those skilled in the art will readily appreciate that the connection assembly 102 may be modified in dimensions and exact configurations. For example, the support 116 may vary to support pads 118 of varying sizes and shapes. In addition, the size of the plate 104 could vary to provide for large or smaller degrees of adjustment.

In embodiments, a pin 108 is coupled to the member 115 via a pin receiver 105. The pin receiver 105 specifically supports the pin 108 in at least two configurations including a locked configuration and a free configuration. In the locked configuration, the pin 108 extends through the receiver 105 and into a selected one of the plurality of apertures 106 to lock the rotating connection at a predetermined angle. In other words, the user can disengage the pin 108, rotate the entire connection 107 such that the pad 118 rotates along with the connection 107, and then lock the pin 108 into one of the desired apertures. This provides locked adjustment of the user engageable apparatus (i.e. pad 118). The free configuration allows for the pin 108 to disengage from the plurality of apertures 106 entirely and remain locked in this disengaged or free position. Accordingly, as pressure is applied or released against the pad 118, the connection 107 will freely rotate. In other words, the connection 107 becomes self adjusting during use. In embodiments, the pin receiver 106 in combination with the pin 108 provide for this disengaged/free configuration. The pin 108 can be pulled free, rotated, and then released, wherein an internal catch system will then prevent the pin 108 from extending through the receiver 105 and into any of the apertures 106. Alternatively, the receiver 105 may be threaded such that the pin 108 is rotated inward or outward therefrom to lock into one of the configurations.

Those skilled in the art will appreciate that disengagement of the pin 108 from the plurality of apertures 106 and locking the pin 108 in this disengaged configuration, may be achieved through various means.

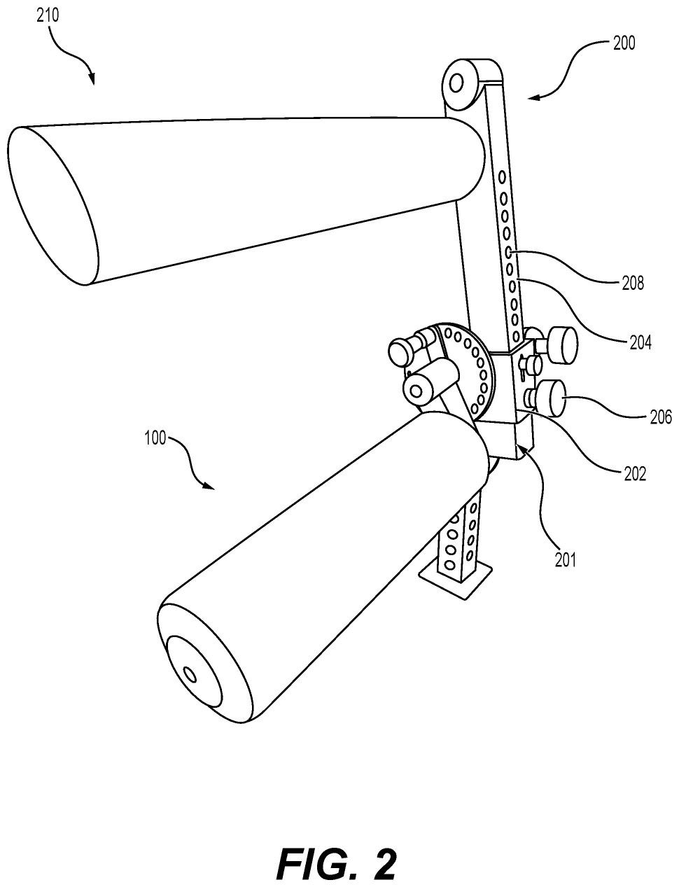

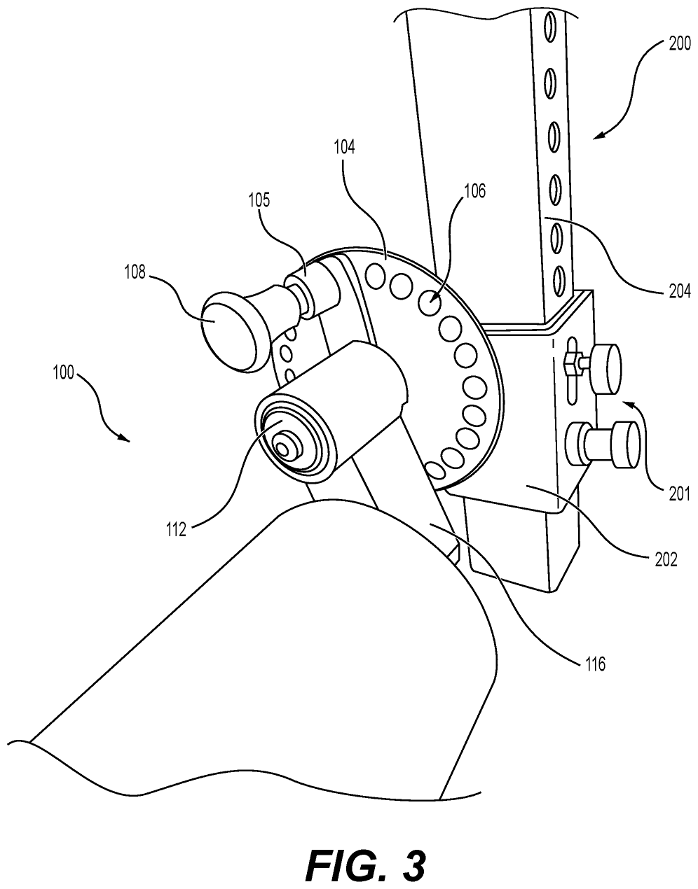

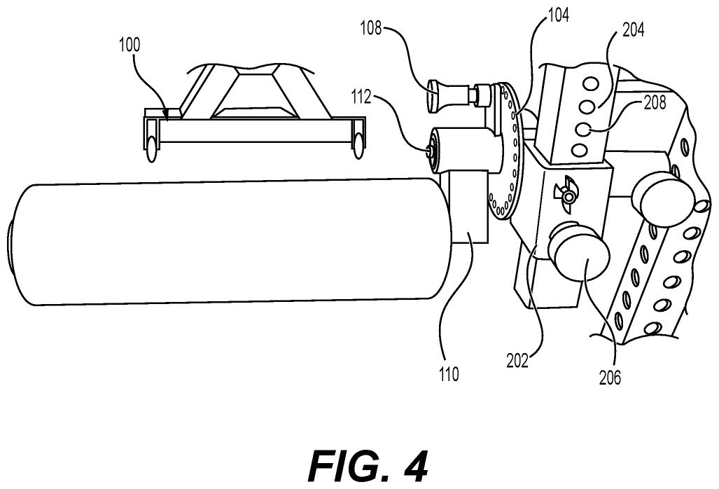

As best shown in FIGS. 2-4, the self-adjusting roller 100 can engage with an exercise machine 200 for use by the user. For example, the roller 100, in embodiments, includes a connector 110 extending from the plate 104 in a direction opposite of the pad 118. The connector 110 can vary, but in at least some embodiments, includes one or more sections 114 that have hexagonal cross sections. The hexagonal cross sections provide for improved securement of the connector 110 to a hex port sleeve 201.

In embodiments, the connector 110 engages with a trolley 202 of the hex port sleeve 201 that is further engaged with a post 204 of the exercise machine 200. The trolley 202 allows for adjustability of the self-adjusting roller 100 along the post 204. For example, the trolley 202 supports one or more trolley pins 206 that will selectively extend through one of a plurality of apertures 208 along the post 204 thereby locking the self-adjusting roller 100 at a desired height.

The exercise machine 200 will also include embodiments of a user support system 210 which may vary and include various pads, seats, handles, bars, or the like that could be useful in performing a desired exercise utilizing the self-adjusting roller 100.

The embodiments disclosed herein are specifically related to a self-adjusting roller 100 for use in leg exercises. This specifically removes the need of a user to adjust the roller each time they utilize the machine after someone of a different height. This is specifically useful in a gym setting, or in a home with multiple users.

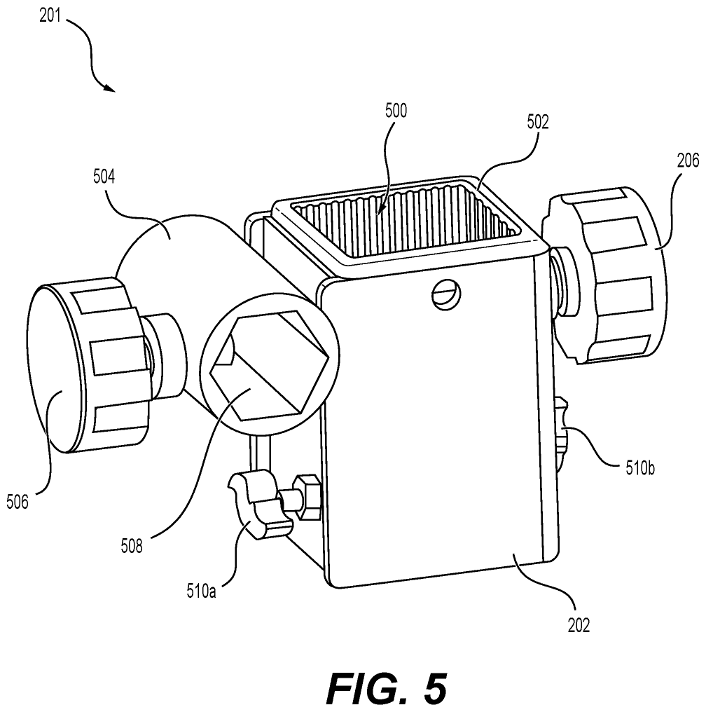

In FIG. 5, the hex port sleeve 201 is shown in detail. The hex port sleeve 201 includes the trolley 202 which forms a channel 500 to receive the post 204 of the exercise machine 200 therein. The channel 500 includes a protective sleeve 502 which can provide additional grip and resistance against the post 204. As previously discussed, one or more trolley pins 206 extend through the trolley 202 and into the channel 500, wherein the pin(s) 206 will insert into an aperture of the post 204, thereby locking the hex port sleeve 201 at a desired height.

The hex port sleeve 201 also includes a receiver 504 coupled to the trolley 202. The receiver 504 having a locking pin 506 again to lock the connector 110 therein. The receiver 504 forms a hexagonal port 508 to correspond to the hexagonal sections 114 of the connector 110. The use of hexagonal shapes, as opposed to circular or round cross sections, creates a more secure lock between the two components. Lastly, the hex port sleeve 201 includes one or more locking bolts 510a-b that tighten into the channel 500 again creating a secure lock against the post 204 when installed.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure. It will be understood that certain features and subcombinations are of utility and may be employed without reference to other features and subcombinations. Not all steps listed in the various figures need be carried out in the specific order described.

1. A self-adjusting roller for user with an exercise machine, the self-adjusting roller comprising:
a connection assembly, having:
a plate with a plurality of apertures extending through the plate;
a rotating connection extending from the plate, the rotating connection having a center body with a member extending therefrom and a support extending therefrom, the center body has a center axis around which the center body can rotate;
a pin receiver coupled to the center body via the member; and
a pin extending into the pin receiver, the pin receiver selectively supporting the pin in a locked configuration and in a free configuration;
wherein, when in the locked configuration, the pin extends through a selected one of the plurality of apertures; and
wherein, when in the free configuration, the pin is retained out of any of the plurality of apertures;
a user engageable apparatus coupled to the support;
wherein the user engageable apparatus is configured to be manipulated by a user during an exercise;
wherein the user can select between the locked configuration and the free configuration; and
wherein the free configuration allows the user engageable apparatus to self-adjust during use.

2. The self-adjusting roller of claim 1, wherein pin receiver is configured such that the pin can extend therethrough and into the selected one of the plurality of apertures or the pin can be rotated such that the pin is locked into the free configuration.

3. The self-adjusting roller of claim 1, further comprising:
a connector extending from the plate and configured to engage with the exercise machine to couple the self-adjusting roller to the exercise machine.

4. The self-adjusting roller of claim 3, wherein the connector is configured to couple to a trolley of a hex port sleeve, the hex port sleeve coupled to the exercise machine.

5. The self-adjusting roller of claim 4, wherein the connector includes at least one section with a hexagonal cross-section.

6. The self-adjusting roller of claim 1, wherein the user engageable apparatus is a pad.

7. A combination of a self-adjusting roller and a hex port sleeve as part of an exercise machine, the combination comprising:
the self-adjusting roller, having:
a connection assembly, having:
a plate with a plurality of apertures extending through the plate;
a rotating connection extending from the plate, the rotating connection having a center body with a member extending therefrom and a support extending therefrom, the center body has a center axis around which the center body can rotate;
a pin receiver coupled to the center body via the member;
a pin extending into the pin receiver, the pin receiver selectively supporting the pin in a locked configuration and in a free configuration; and
a connector extending from the plate;
wherein, when in the locked configuration, the pin extends through a selected one of the plurality of apertures; and
wherein, when in the free configuration, the pin is retained out of any of the plurality of apertures;
a user engageable apparatus coupled to the support;
wherein the user engageable apparatus is configured to be manipulated by a user during an exercise;
wherein the user can select between the locked configuration and the free configuration; and
wherein the free configuration allows the user engageable apparatus to self-adjust during use;
the hex port sleeve, having:
a trolley forming a channel to receive a post of the exercise machine;
a trolley pin extending into the channel to lock the trolley at a location along the post;
a receiver coupled to the trolley, the receiver having a port to receive the connector, thereby coupling the self-adjusting roller to the hex port sleeve; and
a locking pin extending into the port to lock the connector therein.

8. The combination of claim 7, wherein pin receiver is configured such that the pin can extend therethrough and into the selected one of the plurality of apertures or the pin can be rotated such that the pin is locked into the free configuration.

9. The combination of claim 7, wherein the connector includes at least one section with a hexagonal cross-section.

10. The combination of claim 9, wherein the port is a hexagonal shape such that the port coordinates with the at least one section of the connector.

11. The combination of claim 7, wherein the user engageable apparatus is a pad.

12. The combination of claim 7, wherein the hex port sleeve further comprises one or more locking bolts configured to tighten into the channel.
